(19) United States
(12) Patent Application Publication
(10) Pub. No.: US 2010/0228851 A1
(43) Pub. Date: Sep. 9, 2010

(54) Aggregating and Reporting of Performance Data Across Multiple Applications and Networks

(76) Inventors: Mark Francis, Flemington, NJ (US); Charles Kerschner, Piscataway, NJ (US)

Correspondence Address: AT&T Legal Department - HBH;Attn: Patent Docketing, One AT&T Way, Room 2A-207, Bedminster, NJ, 07921, US

(21) Appl. No.: 12/399,123

(22) Filed: Mar. 6, 2009

(51) Int. Cl. G06F 15/173; H04L 12/26

(52) U.S. Cl. 709/224; 370/252

(57) ABSTRACT

This description provides tools and techniques for aggregating and reporting of performance data across multiple applications and networks. These tools may provide apparatus for transforming visible characteristics of a graphical user interface. The graphical user interface may include representations of different physical networks, and may include representations of status indicators, with the representations of the physical networks being associated with one or more corresponding status indicators. These status indicators may represent respective performance levels computed for the different physical networks. More specifically, the performance levels relate to components of the physical networks or applications running on the physical networks. The graphical user interface may also respond to changes in the performance levels that are computed for the physical networks, to transform the status indicators that are associated with the physical networks

### BACKGROUND

Network management continues to be an ongoing challenge, particularly for large enterprises that may maintain numerous different physical networks. When such enterprises are facing performance issues within these networks, it may be difficult to identify which particular network or networks are experiencing these performance issues. These enterprises may operate network operation centers (NOCs), which facilitate management of the different networks. These NOCs may incorporate graphical or visual displays of network status information. However, for enterprises that manage large numbers of different networks, the amount of information presented within the NOCs may be overwhelming to human users. In addition, the network information presented in existing NOCs is typically segregated by individual networks.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This description provides tools and techniques for aggregating and reporting of performance data across multiple applications and networks. These tools may provide apparatus for transforming visible characteristics of a graphical user interface. The graphical user interface may include representations of different physical networks, and may include representations of status indicators, with the representations of the physical networks being associated with one or more corresponding status indicators. These status indicators may represent respective performance levels computed for the different physical networks. More specifically, the performance levels relate to components of the physical networks or applications running on the physical networks. The graphical user interface may also respond to changes in the performance levels that are computed for the physical networks, to transform the status indicators that are associated with the physical networks.

Other apparatus, systems, methods, and/or computer program products according to embodiments will be or become apparent to one with skill in the art upon reviewing the following drawings and Detailed Description. It is intended that all such additional apparatus, systems, methods, and/or computer program products be included within this description, be within the scope of the claimed subject matter, and be protected by the accompanying claims.

### BRIEF DESCRIPTION OF THE DRAWINGS

FIG. 1 is a combined block and flow diagram illustrating systems or operating environments for aggregating and reporting of performance data across multiple applications and networks.

FIG. 2 is a combined block and flow diagram illustrating additional components of a network or application status server shown in FIG. 1.

FIG. 3 is a combined block and flow diagram illustrating components and process flows by which a network or application aggregation and reporting tools may operate.

FIG. 4 is a combined block and flow diagram illustrating additional examples of output from comparators that are shown in FIG. 3.

FIG. 5 is a block diagram illustrating details of a network or application dashboard display.

FIG. 6 is a block diagram illustrating additional details that the network or application dashboard display may present in response to user selection of status fields shown in FIG. 5.

FIG. 7 is a combined block and flow diagram illustrating process related to aggregating and reporting of performance data across multiple applications and networks.

FIG. 8 is a combined block and flow diagram illustrating processes for updating rules, limits, and/or metrics in light of the patterns or linkages observed between cross-network or cross-application anomalies.

### DETAILED DESCRIPTION

The following detailed description is directed to methods, systems, and computer-readable media for aggregating and reporting of performance data across multiple applications and networks. While the subject matter described herein is presented in the general context of program modules that execute in conjunction with the execution of an operating system and application programs on a computer system, those skilled in the art will recognize that other implementations may be performed in combination with other types of program modules.

According to exemplary embodiments, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

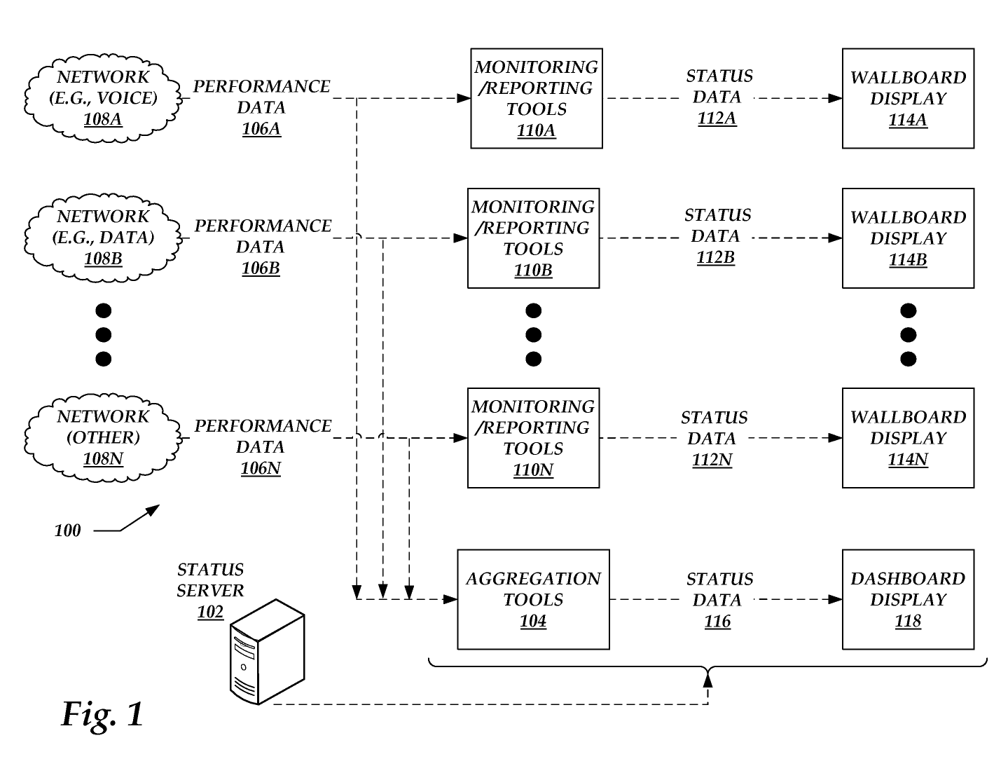

FIG. 1 illustrates systems or operating environments, denoted generally at 100, for aggregating and reporting of performance data across multiple applications and networks. These systems 100 may include any number of servers, workstations, or other computing systems, denoted generally as one or more network or application status servers 102. For clarity of illustration, FIG. 1 and subsequent drawings may refer to “network” components. However, this description also applies equally to applications running on these network components.

Turning to the network or application status servers 102 (collectively, status servers 102) in more detail, these status servers may provide network or application aggregation tools 104 (collectively aggregation tools 104). These aggregation tools 104 may represent combinations of hardware and/or software that are operative to receive network or application performance data 106a, 106b, and 106n (collectively, performance data 106) respectively from different physical networks 108a, 108b, and 108n (collectively, physical networks 108).

The physical networks 108 also represent applications running on such physical networks. Examples of such applications may include, but are not limited to, e-mail applications deployed over the physical networks 108, location-based services similarly deployed over the physical networks 108, personal mobility applications accessible via wireless communication devices (e.g., cellular phones, smartphones, personal digital assistants (PDAs), and the like), and other similar applications. Accordingly, while the description herein may in some places refer to monitoring and reporting the status of physical networks, this description applies equally to monitoring and reporting the status of applications running on such physical networks.

In the example shown in FIG. 1, the network 108a is a voice network, the network 108b is a data network, and the network 108n is a network of another type. However, it is understood that these networks 108 are provided as examples only, and do not limit possible implementations of this description. In addition, networks 108a-108n may represent more than one instance of these different networks, with FIG. 1 providing one instance of these networks 108a-108n only for clarity of illustration. Any of the foregoing applications may run on the networks 108a and/or 108b.

The networks 108 are referred to as separate physical networks, in the sense that they represent different, independent instances of network stacks, models, or other architectures. For example, assuming the networks 108 are implemented according to the Open Standards Interconnect (OSI) networking model, the different networks 108a-108n may be associated with different instantiations of the OSI model.

The performance data 106 may be transmitted to respective instances of monitoring and/or reporting tools 110a, 110b, and 110n (collectively monitoring/reporting tools 110). The monitoring/reporting tools 110 may track any number of different parameters related to how the networks 108 function or operate over time. For example, the monitoring/reporting tools 110 may indicate the status of various components within the networks 108, with examples of these components including (but not limited to) routers, switches, and the like. In addition, the monitoring/reporting tools 110 may track parameters indicating the status of different applications running on the networks 108.

FIG. 1 denotes the outputs of the monitoring/reporting tools 110 as status data 112a, 112b, and 112n (collectively, status data 112). This status data 112 may represent current operating status of network components and/or applications running on those network components. In general, this status data 112 may indicate visually to human users how the corresponding networks 108a-108n are operating at a given time. More specifically, respective wallboard display devices 114a, 114b, and 114n (collectively wallboard displays 114) may present the status data 112 may form visible to the human users. According to exemplary embodiments, each network 108a-108n corresponds to one wallboard display 114a-114n, such that one given wallboard display 114 presents status information associated with one given network 108 (or applications running on that network 108).

In some cases, these systems 100 may be deployed within a network operations center (NOC), with the NOC providing the capability to monitor a plurality of the networks 108 through the wallboard displays 114. However, in some cases, the number of networks 108 and corresponding wallboard displays 114 may be numerous (e.g., in the dozens). In such scenarios, it may be difficult for human administrators to track and monitor the status of these numerous different networks 108 and wallboard displays 114.

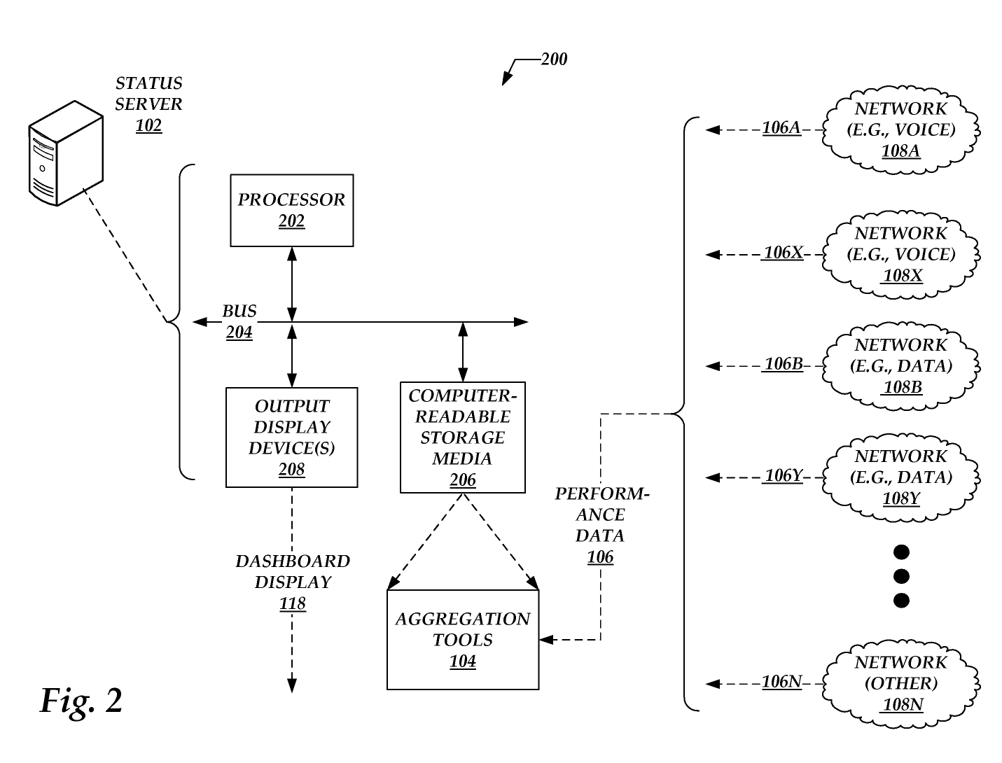

In such implementations scenarios, the aggregation tools 104 may receive the network and/or application performance data 106a-106n from the various networks 108a-108n. Using techniques described in further detail below, the aggregation tools 104 may process the performance data 106 to generate aggregated network and/or application status data 116 (collectively, status data 116). In turn, a dashboard display 118 may provide representations of consolidated or aggregated status for the networks 108a-108n and any applications executing thereon. An exemplary status server 102 is now described further with FIG. 2.

FIG. 2 illustrates additional components, denoted generally at 200, of the status server 102. For ease of reference and description, but not to limit possible implementations, FIG. 2 may carry forward some elements described in previous Figures, and may denote them with identical reference numerals.

Turning to the status server 102 in more detail, it may include one or more processors 202, which may have a particular type or architecture, chosen as appropriate for particular implementations. The processors 202 may couple to one or more bus systems 204 chosen for compatibility with the processors 202.

The server 102 may also include one or more instances of computer-readable storage medium or media 206, which couple to the bus systems 204. The bus systems 204 may enable the processors 202 to read code and/or data to/from the computer-readable storage media 206. The media 206 may represent apparatus in the form of storage elements that are implemented using any suitable technology, including but not limited to semiconductors, magnetic materials, optics, or the like. The media 206 may include memory components, whether classified as RAM, ROM, flash, or other types, and may also represent hard disk drives.

The storage media 206 may include one or more modules of instructions that, when loaded into the processor 202 and executed, cause the servers 102 to perform various techniques related to aggregating and reporting of performance data across multiple applications and networks. As detailed throughout this description, these modules of instructions may also provide various tools or techniques by which the servers 102 may provide the aggregating and reporting of performance data across multiple applications and networks, using the components, flows, and data structures discussed in more detail throughout this description. For example, the storage media 108 may include one or more software modules that implement the aggregation tools 104.

Turning to the aggregation tools 104 in more detail, these tools may receive the performance data 106, which in turn may include respective performance data 106a-106n as received from the various networks 108a-108n and applications running thereon. FIG. 2 provides an example in which the aggregation tools 104 receive performance data 106a and 106x from two or more different voice networks 108a and 108x. Continuing this example, the aggregation tools 104 may receive performance data 106b and 106y from two or more different data networks 108b and 108y.

The aggregation tools 104 may operate to transform the performance data 106 into the dashboard display 118 (represented in FIG. 2 for convenience of illustration by the line denoted at 118). More specifically, the status server 102 may include any number of output display devices 208, which are suitable for presenting the dashboard display 118 in a manner perceptible by human users and/or administrators. For example, the aggregation tools 104 may generate output signals are presenting the dashboard display 118 onto the bus system 204. In turn, the output display devices 208 may receive these output signals from the bus systems 204 and may render and present the dashboard display 118 in response.

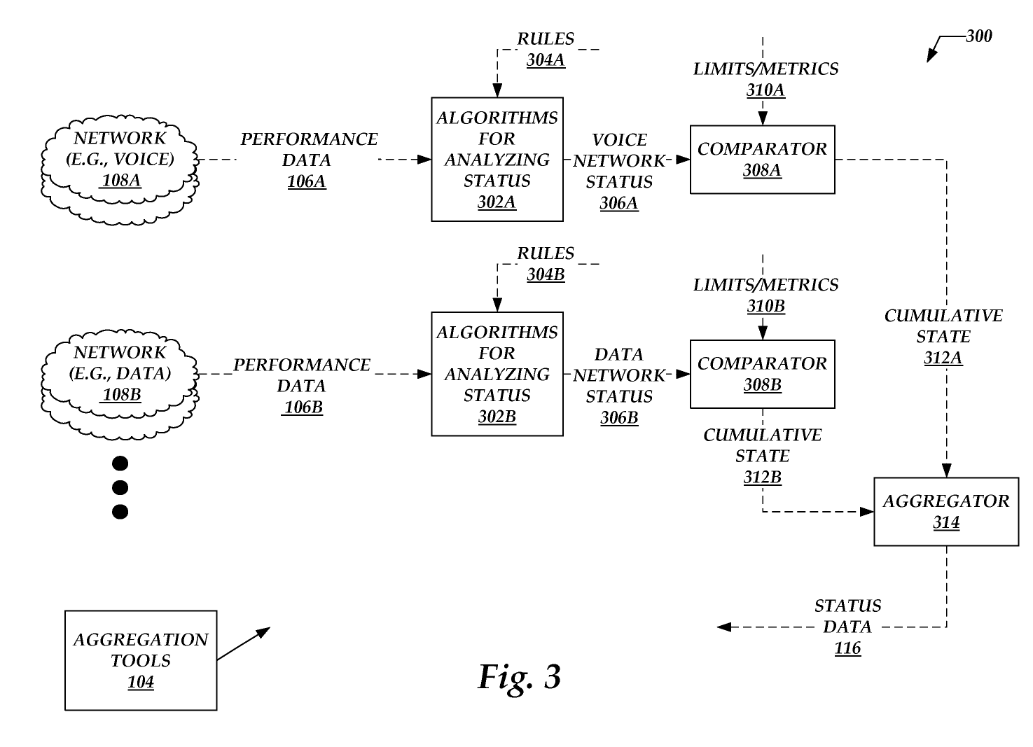

In the foregoing manner, the aggregation tools 104 may transform the status server 102 from a general-purpose computing platform into a special-purpose computing platform suitable for presenting the dashboard display 118. The aggregation tools 104 are described in more detail now with FIG. 3.

FIG. 3 illustrates components and process flows, denoted generally at 300, by which the aggregation tools 104 may operate. For ease of reference and description, but not to limit possible implementations, FIG. 3 may carry forward some elements described in previous Figures, and may denote them with identical reference numerals.

Turning to the components and process flows 300 in more detail, the aggregation tools 104 may include analytical algorithms 302a and 302b (collectively, algorithms 302). These algorithms 302 may receive the network and/or application performance data 106a and 106b respectively from the voice network 108a and from the data network 108b. Once again, it is noted that these examples of the voice network 108a and the data network 108b are chosen only for the purposes of presenting this description, but not to limit possible implementations of this description.

Turning to the algorithms 302 in more detail, the algorithms 302 may be specialized or adapted as appropriate, depending on the type of network or application 108 with which the algorithms 302 operate. For example, the algorithms 302a may be specialized to process performance data 106a received from the voice network 108a, and the algorithms 302b may be specialized to process performance data 106b received from the data network 108b.

On an ongoing basis, the algorithms 302 may incorporate respective rules 304a and 304b (collectively, rules 304) that are applied to the incoming performance data 106a and 106b. The algorithm 302 may generate output network status signals 306a and 306b (collectively, network status signals 306), which result from applying the rules 304 to the incoming performance data 106. In the example shown in FIG. 3, the network status signals 306a pertain to the voice network 108a (and any applications running at least partially thereon), and thus are denoted as voice network status signals 306a. Similarly, the network status signals 306b pertain to the data network 108b (and any applications running at least partially thereon), and thus are denoted as data network status signals 306b.

Turning to the rules 304 in more detail, these rules 304 may specify particular operational conditions occurring within the various networks or applications 108, for which the algorithms 302 are to test over time. For example, assuming that the performance data 106 specifies operational characteristics of various components or applications within the networks 108, the algorithms 302 and/or rules 304 may specify various ranges and/or thresholds applicable to these operational characteristics. At a given time, the algorithms 302 may sample the operational characteristics within the performance data 106, and depending on where these operational characteristics fall relative to these ranges and/or thresholds, the algorithms 302 may output appropriate network status signals 306.

In example scenarios, a given network 108 may include given routers, switching circuits, or other similar components. In addition, the given network 108 may support any number of applications running on the network. In such scenarios, the algorithms 302 and rules 304 may specify ranges or thresholds applicable to the operational characteristics of these components and/or applications. In turn, the network status signals 306 reflect how these components and/or applications are operating at a given time, relative to the applicable ranges and thresholds.

The aggregation tools 104 may also provide any number of comparators 308a and 308b (collectively, comparators 308), which may receive the network status signals 306a and 306b, respectively. For example, a first set of status signals 306a may indicate how a first voice network 108a is operating at a given time, while another set of status signals 306a may indicate how a different physical voice network 108a is operating at a given time. The comparator 308a may analyze these status signals 306a against a set of applicable limits or metrics 310a. In turn, the comparator 308a may generate signals 312a representing a cumulative state of the voice networks. In addition, the signals 312a output from the comparator 308a may also represent status of any applications executing at least in part on the voice networks.

Although FIG. 3 illustrates a scenario in which the comparator 308a receives the status signals 306a from one voice network 108a, the comparator 308a may also receive status signals 306a from multiple voice networks 108a. In this manner, the comparator 308a may gain visibility across the multiple voice networks 108a, and may monitor operational status of these different voice networks. More specifically, the comparator 308a may apply the limits or metrics 310a to these multiple voice networks, and may define the cumulative state signals 312a based upon the overall performance of these multiple voice networks.

In addition, the comparator 308a may gain visibility into the operational status of applications running on these different voice networks. Further, the comparator 308a may apply the limits or metrics 310a to applications running on these multiple voice networks. Finally, the comparator 308a may define the cumulative state signals 312 to incorporate status of these applications as running on the different voice networks.

In an example implementation scenario, the comparator 308a may receive network status signals 306a from each of three different voice networks 108a at a given time. The comparator 308a may apply the limits 310a to each of the work status signals 306a to determine the current operational status of different voice networks 108a at that time. For example, the network status signals 306a may indicate that the first and second voice networks 108a are operating at an “excellent” status, but that a third voice network is operating at a “poor” status. The limits 310 may specify how to define or formulate the cumulative state signals 312a in this scenario. For example, even though two out of the three voice networks 108a are operating at an “excellent” status, the cumulative state signals 312a may nevertheless be set to a “poor” status, in order to draw attention to the underperforming voice network. The foregoing description may also apply to any applications running on these different voice networks.

Similar considerations may apply to the comparator 308b, which may receive network status signals 308b that indicate operational characteristics of one or more data networks 108b at a given time. More specifically, the comparator 308b may apply limits or metrics 310b to the network status signals 308b, resulting in signals 312b that represent a cumulative state of the voice networks 108b. The foregoing description may also apply to any applications running on these data networks.

Generalizing the above description of the comparators 308, the comparators 308 may apply different limits or metrics 310a and 310b (collectively, limits 310) that are defined as appropriate for different types of networks 108. For example, the limits 310a defined for voice networks 108a may or may not be the same as the limits 310b defined for data networks 108b. Extending beyond voice or data networks to other networks, or types of networks, network aggregation tools 104 may facilitate the definition of any limits 310 that may be suitable for such networks, or applications running thereon.

The aggregation tools 104 may provide an aggregator component 314, which is operative to receive any number of cumulative state signals (e.g., 312a and 312b, collectively 312) from comparators (e.g., 308a and 308b). In general, the aggregator 314 may organize the cumulative state signals 312 for presentation to human users as network status data 116 on the dashboard display 118.

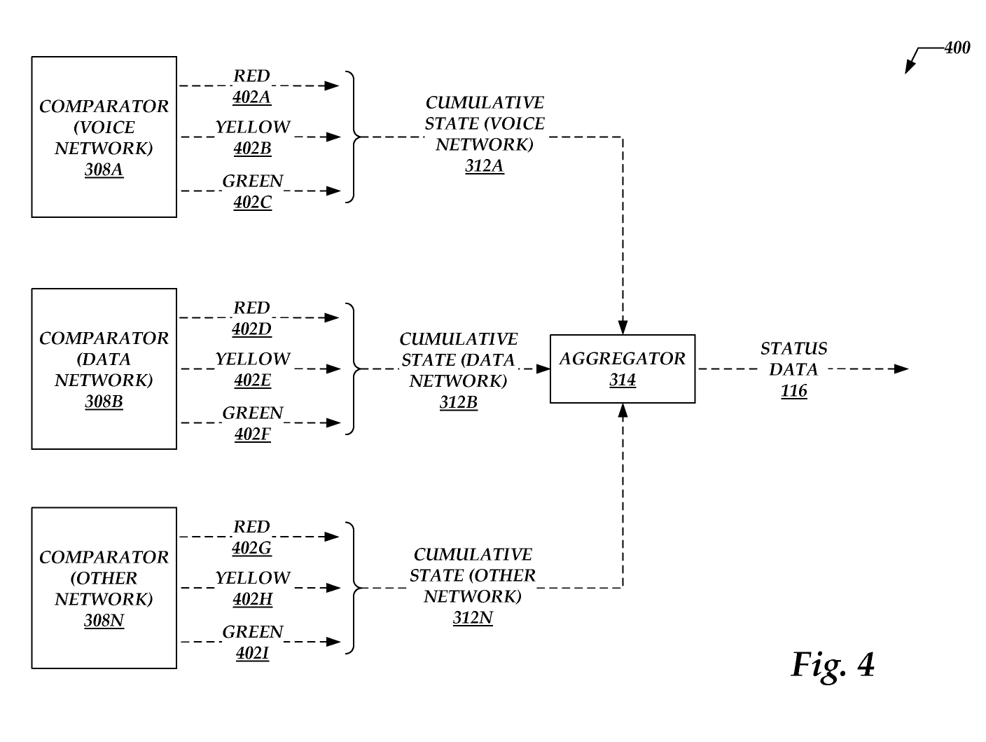

FIG. 4 provides additional examples, denoted generally at 400, of output from the comparators 308. For ease of reference and description, but not to limit possible implementations, FIG. 4 may carry forward some elements described in previous Figures, and may denote them with identical reference numerals.

FIG. 4 illustrates scenarios in which the comparator 308a receives inputs from one or more voice networks, the comparator 308b receives inputs from one or more data networks, and the comparator 308n receives inputs from one or more other networks. As described above in FIG. 3, the comparators may weigh or analyze these inputs as specified by the limits 310, so as to define the cumulative network state signals 312a, 312b, and 312n. In turn, the aggregator 314 may receive these network state signals 312a-312n, and may render them as appropriate for visual display as network status data 116 on a dashboard display (e.g., 118 in FIG. 1).

Turning to the network state signals 312 in more detail, these state signals 312 may be visualized by using a color-coding scheme. For example, turning to the comparator 308a for the voice networks, this comparator may assess the overall or cumulative condition of the voice networks as red, yellow, or green (denoted respectively at 402a, 402b, and 402c). The “red” condition 402a may indicate that the voice networks (and/or applications running at least partially thereon), considered cumulatively, are operating in a “poor” status. It is noted that the “red” condition 402a may not necessarily mean that all of the voice networks are operating in a poor status. Instead, the “red” condition 402a may serve to draw administrative attention to one or more of the voice networks that operationally underperforming at a given time.

The “yellow” condition 402b may indicate that the voice networks, considered cumulatively, are operating in a “fair” status. The “yellow” condition 402b may serve to draw administrative attention to one or more voice networks that, at a given time, are not yet underperforming, but may begin underperforming relatively soon.

The “green” condition 402c may indicate that the voice networks, considered cumulatively, are operating in a “good” status. The “green” condition 402c may serve to notify administrative personnel that the voice networks are operating normally and do not need attention at a given time. In the foregoing manner, the cumulative state signals 312a associated with the voice networks may, for example, take on any of the example conditions 402a-402c at any given time

Turning to the comparator 308b associated with the data networks (and/or applications running at least partially thereon), similar considerations apply to “red” condition 402d, “yellow” condition 402e, and “green” condition 402f, as output from this comparator 308b. Thus, the cumulative state signals 312b associated with the data networks may, for example, take on any of the example conditions 402d-402f at any given time.

Turning to the comparator 308n associated with other networks (and/or applications running at least partially thereon), similar considerations apply to “red” condition 402g, “yellow” condition 402h, and “green” condition 402i, as output from this comparator 308n. Thus, the cumulative state signals 312n associated with the other networks may, for example, take on any of the example conditions 402g-402i at any given time.

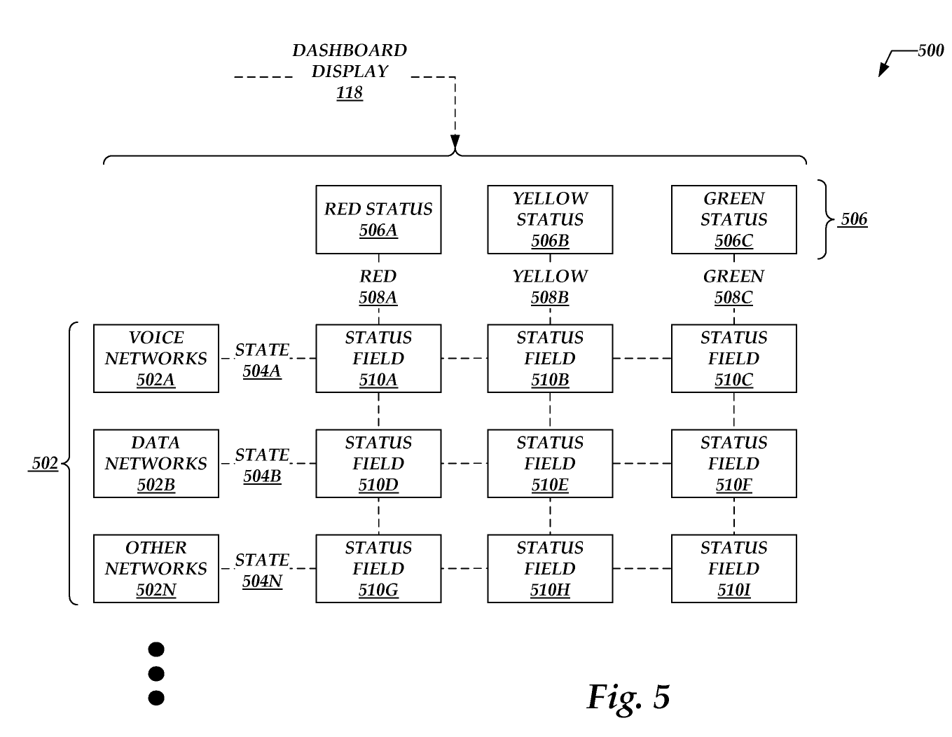

The aggregator 304 may combine and/or integrate the various cumulative network state signals 312 to status data 116. In turn, this status data 116 may be rendered visually on a suitable dashboard display (e.g., 118 in FIG. 1). An example dashboard display 118 is now described with FIG. 5.

In providing the examples shown in FIG. 4, it is noted that implementations of this description may or may not use color coding to describe the states or conditions of the various networks. Instead, the color codes shown in FIG. 4 and subsequent drawings are provided only for ease of visualization. In addition, some implementations may employ visualization schemes that incorporate other colors or categories.

Although FIG. 4 illustrates three general categories of status as output by the comparators 308, it is noted that implementations of this description may use any number of discrete categories. As an alternative to some number of discrete categories, implementations of this description may also incorporate continuous transitions between these categories, as described further below in FIG. 5.

FIG. 5 illustrates additional details, denoted generally at 500, of the dashboard display 118. For ease of reference and description, but not to limit possible implementations, FIG. 5 may carry forward some elements described in previous Figures, and may denote them with identical reference numerals. More specifically, FIG. 5 illustrates in block form an illustrative, but non-limiting, configuration of the dashboard display 118.

Turning to the dashboard display 118 in more detail, this display 118 may include representations, denoted generally at 502, for different categories of physical networks. FIG. 5 presents an example in which the dashboard display 118 includes a representation 502a of one or more voice networks, a representation 502b of one or more data networks, and a representation 502n of another network. The dashboard display 118 may arrange cumulative state information associated with these different network types in rows, as represented generally at 504a, 504b, and 504n (collectively, rows 504). In addition, the network representations 502a-502n (collectively, network representations 502) may also depict applications running on these different physical networks.

The dashboard display 118 may also include representations, denoted generally at 506, for different status levels associated with the physical networks and/or applications running thereon. FIG. 5 presents an example in which the dashboard display 118 includes a representation 506a corresponding to a “red” status or condition, a representation 506b corresponding to a “yellow” status or condition, and a representation 506c corresponding to a “green” status or condition. The dashboard display 118 may arrange different categories of status information in columns, as represented generally at 508a, 508b, and 508c (collectively, columns 508).

Considered together, the rows 504 and the columns 508 may form a matrix configuration suitable for implementing the dashboard display 118. The intersections between the rows 504 and the columns 508 may provide status fields, which may be activated or deactivated as appropriate to indicate the current conditions of different networks and/or applications running thereon. For example, turning first to the representation 502a of the voice networks and referring to the row 504a, if the voice networks as a whole are underperforming (i.e., in a “red” status), then a status field 510a may be activated, and status fields 510b and 510c may be de-activated. In this manner, a human administrator may briefly review the dashboard display 118, and readily notice that the voice networks (including any applications running thereon) as a whole are currently in a “red” status. Similar considerations would apply when the voice networks are in a “yellow” or “green” status.

Turning to the data network and associated row 504b, any of the status fields 510d-510f may be activated or deactivated at any given time to indicate the current status or condition of the data network and/or applications running thereon. Similarly, turning to the other network and associated row 504n, any of the status fields 510g-510i may be activated or deactivated at any given time to indicate the current status or condition of this other network and/or applications running thereon.

FIG. 5 illustrates a scenario in which the dashboard display 118 incorporates representations 502 of three different networks, along with three possible discrete states or conditions for these networks. This example results in a 3×3 matrix, with nine status fields 510a-510i (collectively, status fields 510) provided at the intersections of this matrix. However, it is noted that this example is provided only to facilitate the present description, but not to limit possible implementations of this description. For example, implementations of the dashboard display 118 may include representations 502 of any number of different physical networks of different types, however grouped or organized.

Implementations of the dashboard display 118 may organize network or application status or conditions into any number of discrete categories. However, the dashboard display may also incorporate additional indicators (not shown in FIG. 5 in the interest of clarity) between adjacent status fields 510. These additional indicators may be activated as appropriate when the corresponding network or application transitions from one state or condition to another. For example, assume that the data networks are currently in a “yellow” condition, such that the status field 510e is activated. If operating conditions in the data networks continue to deteriorate, the data networks may eventually assume a “red” status. However, as these operating conditions continue to degrade, additional indicators between the status fields 510d and 510e may be activated to represent this continued degradation.

Continuing this example, in which the data networks are currently in “yellow” status, when operating conditions in the data networks are improving, additional indicators between the status fields 510e and 510f may be activated to signify this improvement. Accordingly, these additional indicators may represent improving operating conditions, as well as representing deteriorating operating conditions.

FIG. 5 illustrates a scenario in which cumulative network status is conveyed by activating and/or deactivating different status fields 510. However, implementations of this description may also convey equivalent information by altering the state of a single indicator or status field. For example, the representations 502 of the various networks may be associated with corresponding single fields 510, with these single fields 510 taking on different colors, values, or other characteristics to indicate the current status of the networks.

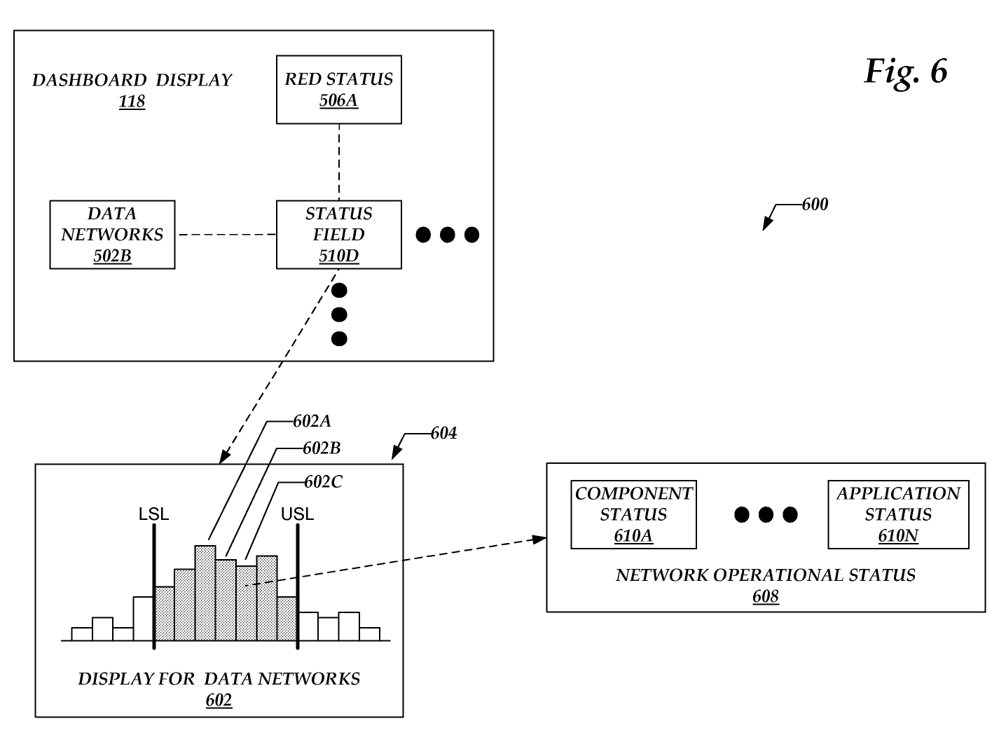

Referring generally to the status fields 510, the status fields may be responsive to user input or activation to select the network or application represented by the status field. For example, assuming that the data networks represented at 502b are in a “red” status at a given time, the status field 510d would be activated so to indicate. If the user then clicks upon or otherwise activates the status field 510d, the dashboard display 118 may respond to this activation by transforming the display, to provide additional details regarding the operational status of the data networks represented at 502b. In this or other similar scenarios, the content presented in the dashboard display 118, shown generally in FIG. 5, may transition to a more detailed display shown by example in FIG. 6.

FIG. 6 illustrates additional details, denoted generally at 600, that the dashboard display may present in response to user selection of one of the status fields, shown in FIG. 5 at 500. For ease of reference and description, but not to limit possible implementations, FIG. 6 may carry forward some elements described in previous Figures, and may denote them with identical reference numerals.

Carrying forward the illustrative and non-limiting example from FIG. 6, the dashboard display 118 may include, at least in part, the column representation 506a corresponding to the red status indicators, the row representation 502b corresponding to the data networks, and the status field 510d at the intersection of these column and row representations. In response to user activation of the status field 510, the dashboard display 118 may transition to a more detailed display of the data networks that are represented at 502b. FIG. 6 denotes this more detailed display generally at 602.

Turning to the more detailed display 602 more specifically, this display 602 may present additional information relating to the network selected from the more higher-level dashboard display 118. For example, continuing the scenario in which the user may investigate operational status of underperforming data networks by selecting the status field 510d, the detailed display 602 may present operational information relating to the various individual data networks that are represented in the dashboard 118 at 502b. In addition, the detailed display 602 may also include representations of one or more applications operating at least in part on the data networks.

In the foregoing manner, the detailed display 602 may enable the user to visualize more readily which particular data network (or networks) is underperforming. In some cases, applications running on these data networks may be underperforming. This visualization may include presenting a histogram, graph, chart, or other suitable user interface (all of which are denoted generally at 604) that represents various operational aspects of the data networks and/or applications running thereon. For example, the data networks that are represented in the aggregate at 502b may include some number of individual data networks, which are represented individually at 606a, 606b, 606c, and so on (collectively, individual network 606). The user interface 604 may vary the representation of the individual networks 606 in some manner, so as to depict their operational status relative to one another and enable human users to readily identify any underperforming individual networks 606 and/or applications running thereon.

Continuing the ongoing example, assume that the individual network represented at 606c is underperforming, with its representation so indicating. The representation of the underperforming individual network 606c may be responsive to user input or activation, thereby transitioning or transforming the user interface 604 to provide still further operational detail on the selected individual network 606c. For example, an additional user interface 608 may be presented, to display more detailed network operational information relating to the selected individual network 606c and/or applications running thereon.

Turning to the user interface 608 in more detail, it may present, for example, operational information on individual components contained within the selected network 606c and/or applications running least in part on the selected network 606c. FIG. 6 provides example representations of such individual components at 610a and provides examples of such applications at 610n (collectively, individual representations 610). However, it is noted that implementations of this description may include representations of any number of individual components. Examples of the individual components or applications represented at 610 may include routers, switches, servers, and the like, as well as applications running on such components. It is also noted that the user interface 608 may include depictions of other operational aspects of the selected network 606c.

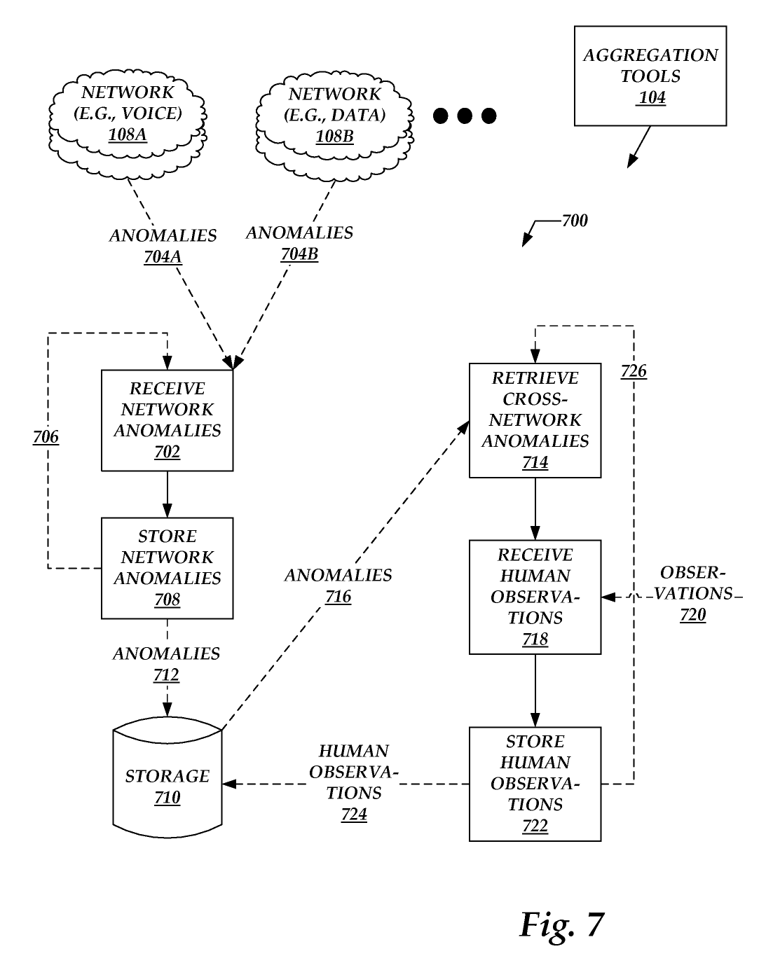

Having described the various user interfaces in FIGS. 5 and 6, the discussion now turns to a description of process flows that the aggregation tools 104 may perform in connection with aggregating and reporting of performance data across multiple networks. This discussion is now presented beginning with FIG. 7.

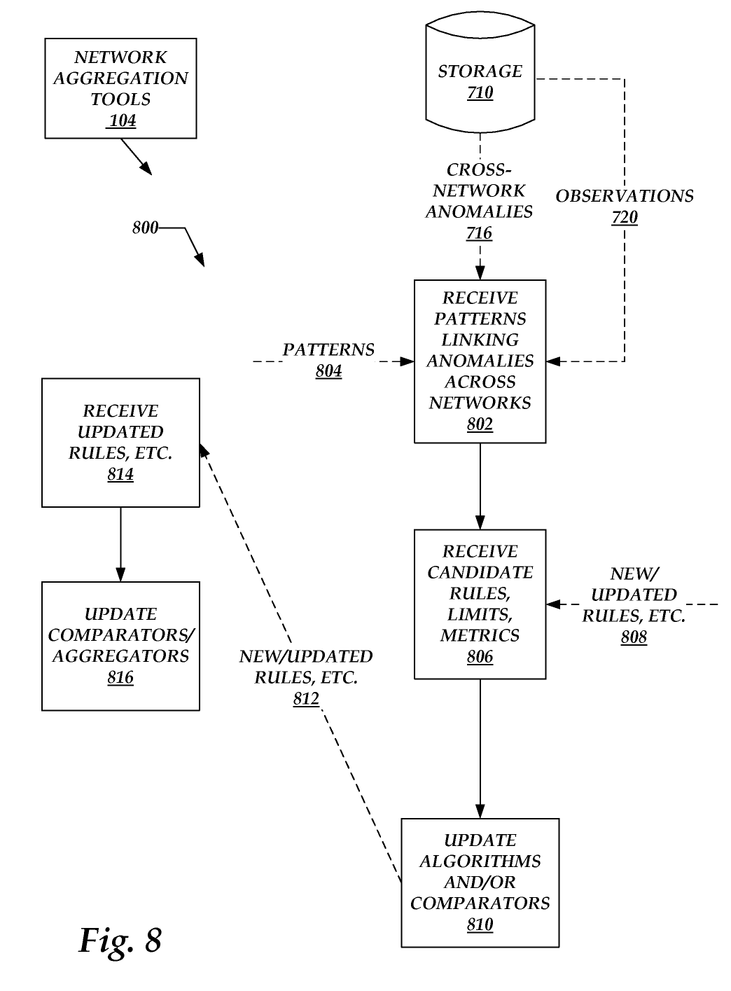

FIG. 7 illustrates process flows, denoted generally at 700, for aggregating and reporting of performance data across multiple networks. For ease of reference and description, but not to limit possible implementations, FIG. 7 may carry forward some elements described in previous Figures, and may denote them with identical reference numerals. In addition, although the process flows 700 (as well as the process flows 800 shown below in FIG. 8) are described in connection with the aggregation tools 104, it is noted that at least portions of these process flows 700 and 800 may be performed with other components without departing from the scope and spirit of the present description.

Turning to the process flows 700 in more detail, block 702 represents receiving indications of performance or operational anomalies occurring in any number of different networks, or different types of networks. For example, as shown in FIG. 7, block 702 may include receiving indications of anomalies 704a occurring in one or more voice networks 108a. Block 702 may also include receiving indications of anomalies 704b occurring within one or more data networks 108b. In addition, block 702 may also include receiving indications of performance anomalies occurring in other types of networks. These performance anomalies 704a-704b (collectively, performance anomalies 704) may effect network components and/or applications running on such network components.

Block 702 may be repeated over time, as represented by the dashed line 706, to collect performance anomaly data from a variety of different networks and/or applications running thereon. As described in further detail elsewhere herein, the aggregation tools 104 may, in contrast to previous techniques for monitoring only one network, may provide visibility across a variety of different physical networks.

Block 708 represents storing representations or indications of the various network performance or operational anomalies, as they may occur on different networks 108. The aggregation tools 104 may provide storage elements 710 that are suitable for containing representations of these performance anomalies. FIG. 7 denotes at 712 the anomalies as loaded into the storage elements 710.

Block 714 represents retrieving and analyzing the performance anomalies as contained in the storage elements 710. FIG. 7 denotes at 716 the anomalies as retrieved from the storage elements 710. Block 714 may also include arranging the performance anomalies for presentation to one or more human users or administrators. More specifically, block 714 may include associating performance anomalies with representations of the different networks on which they occurred. Block 714 may also include indicating when these anomalies occurred. In this manner, block 714 may include organizing and presenting performance anomalies occurring across different physical networks, and/or across different instances of similar types of networks (i.e., cross-network anomalies).

Block 718 represents receiving human observations 720 related to the cross-network anomalies retrieved and presented in block 714. Typically, computer-based systems are proficient at algorithmically or systematically processing vast amounts of data. For example, the network status server 102 may, through the network aggregation tools 104, accumulate and store numerous representations of the network performance anomalies 712 over time. However, as compared to machines, humans are typically better at employing intuition to recognize patterns or linkage between different instances of data (assuming the data is organized and presented somewhat logically). Thus, the network aggregation tools 104 enables machines (e.g., the server 102) to perform systematic tasks at which they are more proficient, while also enabling human administrators or users to perform intuitive tasks at which they are more proficient.

Turning to the human observations 720 in more detail, examples of these observations may include, but are not limited to, recognized patterns or linkages between performance anomalies occurring within a given network, across two or more different networks of the same general type, and/or across two or more networks of different types. For example, human users may review and analyze historical network performance data, and may recognize that when a first performance anomaly “A” occurs in a first network, then a second performance anomaly “B” occurs in another network. The precise reasons for this linkage, as well as the resolution of these anomalies, may or may not be immediately clear. However, the network aggregation tools 104 may facilitate and expedite the recognition of such linkages or patterns between these anomalies, particularly those anomalies occurring across different physical networks. As noted elsewhere herein, these performance anomalies may affect network components and/or applications running on those components.

Block 722 represents storing representations of these human observations. FIG. 7 denotes at 724 the human observations as stored in, for example, the storage elements 710. However, it is noted that implementations of this description may or may not store the human observations 724 in the storage elements 710 that also store the anomalies 712.

As indicated by the dashed line 726, block 714, 718, and 722 may be repeated indefinitely over time to retrieve and analyze performance anomalies, and to receive human observations related to these anomalies. In some cases, different humans may perform different analyses of network anomalies that occur at different times. For example, the first anomaly referred to above may occur during a first shift, with a human administrator working during that shift to note the anomaly, along with any attendant circumstances. During a subsequent shift, another human administrator may review the anomaly as noted during the first shift, and may either supplement the representation of the anomaly with additional observations, or may recognize a pattern linking this anomaly to some other set of circumstances.

Having described the process flows 700 related to retrieving and analyzing the network or application performance anomalies, the discussion now turns to a description of updating rules, limits, and metrics (e.g., as shown at 304 and 310 in FIG. 3) in light of any patterns or linkage observed between cross-network anomalies. This description is now provided with FIG. 8.

FIG. 8 illustrates process flows, denoted generally at 800, related to updating rules, limits, and/or metrics in light of the patterns or linkages observed between cross-network anomalies. For ease of reference and description, but not to limit possible implementations, FIG. 8 may carry forward some elements described in previous Figures, and may denote them with identical reference numerals. In addition, although the process flows 800 are described in connection with the aggregation tools 104, it is noted that at least portions of these process flows 800 may be performed with other components without departing from the scope and spirit of the present description.

Turning to the process flows 800 in more detail, block 802 represents receiving patterns 804 (typically from human users or administrators) that link anomalies occurring across networks. These anomalies may affect network components and/or applications running on the network components. FIG. 8 carries forward examples of the cross-network anomalies at 716, and carries forward examples of the human observations at 720. For example, one or more given human users or administrators may analyze the anomalies 716 and any previous human observations 720, and may infer patterns 804 occurring between different instances of any cross-network anomalies 716.

Block 806 represents receiving candidate new rules, limits, and/or metrics, or updates to existing rules, limits and metrics. FIG. 8 generally denotes these new and/or updated rules at 808. Block 806 may include receiving these new or updated rules from human users or administrators. Returning to the above example, in which occurrences of a first anomaly in a first network are linked to occurrences of a second anomaly in a second network, new or updated rules may specify that the operational status of the first network is to be downgraded when the first anomaly occurs. In addition, these new or updated rules may specify that the operational status of the second network is to be downgraded, anticipating an expected occurrence of the second anomaly. This anticipation may result from the previously detected linkage between occurrences of the first and second anomalies, within the first and second networks.

Block 810 represents sending the new and/or updated rules, limits, and/or metrics 808 to the algorithms (e.g., 302) and/or comparators (e.g., 308). FIG. 8 denotes at 812 the new and/or updated rules as transmitted to the algorithms and/or comparators.

Block 814 represents the algorithms and/or comparators receiving the new or updated rules, limits, or metrics. In turn, block 816 represents updating the algorithms and/or comparators with these rules, limits, or metrics. Having received these updated rules at a given time, the algorithms and/or comparators may then, from that given time forward, apply the updated rules, limits, or metrics in formulating the network status (e.g., 306), as well as in defining the cumulative network states (e.g., 312).

Having provided the above description of FIGS. 1-8, and referring briefly back to FIG. 1, it is noted that the tools and techniques described herein for aggregating and reporting of performance data across multiple networks may involve various transformations. For example, the tools described herein may transform the network performance data 106 from the various networks 108 into aggregated network or application status data 116 for presentation on a dashboard display device 118. In addition, the tools described herein may operate in connection with physical machines, for example, the various components of the network status server 102.

Based on the foregoing, it should be appreciated that apparatus, systems, methods, and computer-readable storage media for aggregating and reporting of performance data across multiple applications and networks are provided herein. Although the subject matter presented herein has been described in language specific to computer structural features, methodological acts, and computer readable media, it is to be understood that the subject matter defined in the appended claims is not necessarily limited to the specific features, acts, or media described herein. Rather, the specific features, acts and mediums are disclosed as example forms of implementing this description.

The subject matter described above is provided by way of illustration only and should not be construed as limiting. Various modifications and changes may be made to the subject matter described herein without following the example embodiments and applications illustrated and described, and without departing from the true spirit and scope of the claimed subject matter, which is set forth in the following claims.

What is claimed is:

1. Apparatus comprising at least one computer-readable storage medium having computer-executable instructions stored thereon that, when executed by a general-purpose computer, transform the general-purpose computer into a special-purpose computer that is operative to:
receive indications of a plurality of performance anomalies occurring on a plurality of different physical networks, wherein the performance anomalies affect components of the physical networks or applications running on the physical networks; and
receive indications of human observations relating at least a first performance anomaly occurring on a first physical network with at least a second performance anomaly occurring on at least a second physical network, wherein the representations indicate linkage between at least the first and the second performance anomalies.

2. The apparatus of claim 1, further comprising instructions to: store representations of the performance anomalies; store representations of the human observations, wherein the representations indicate linkage between at least the first and the second performance anomalies; and store representations of patterns linking occurrences of at least the first performance anomaly to occurrences of the second performance anomaly.

3. The apparatus of claim 1, further comprising instructions to receive at least one candidate rule for updating a status of at least one of the physical networks, in anticipation of at least one future occurrence of the first or second performance anomalies.

4. The apparatus of claim 3, wherein the candidate rule relates the human observations to the performance anomalies.

5. The apparatus of claim 1, as incorporated into a network status server.

6. Apparatus comprising at least one graphical user interface, wherein the graphical user interface comprises:
representations of a plurality of different physical networks;
representations of a plurality of status indicators, wherein the representations of the physical networks are associated with at least one of the status indicators, and wherein the status indicators represent respective performance levels computed for the different physical networks, wherein the performance levels relate to components of the physical networks or applications running on the physical networks; and
wherein the graphical user interface is responsive to changes in the performance levels computed for the physical networks, to transform the status indicators associated with the physical networks.

7. The apparatus of claim 6, wherein a representation of at least a first one of the physical networks is associated with a plurality of status indicators.

8. The apparatus of claim 7, wherein the plurality of status indicators associated with at least the first physical network are adapted to transition continuously between a plurality of states that represent different performance levels computed for the first network.

9. The apparatus of claim 7, wherein the plurality of status indicators correspond respectively to discrete states representing different performance levels of the different physical networks.

10. The apparatus of claim 6, wherein a representation of at least a first one of the physical networks is associated with a single status indicator, wherein the single status indicator transitions between a plurality of predefined states in response to changes in the performance levels computed for the first physical network.

11. The apparatus of claim 6, wherein a representation of at least a first one of the physical networks denotes a plurality of physical networks of a first type, wherein the representation of the first physical network is responsive to user activation to transform a first state of the graphical user interface into at least a second state, wherein the graphical user interface in the second state is adapted to display representations of the physical networks of the first type.

12. The apparatus of claim 11, wherein the second state of the graphical user is responsive to further user activation that is directed to a selected one of the physical networks of the first type, so as to transform the second state of the graphical user interface into a third state.

13. The apparatus of claim 12, wherein the graphical user interface in the third stage is adapted to display representations of a plurality of components comprising the selected physical network of the first type.

14. The apparatus of claim 13, wherein the graphical user interface in the third stage is adapted to display respective performance information computed for the components.

15. The apparatus of claim 11, wherein a representation of at least a further one of the physical networks denotes a plurality of physical networks of a further type, wherein the representation of the further physical network is responsive to user activation to transform the first state of the graphical user interface into at least a third state, wherein the graphical user interface in the third state is adapted to display representations of the physical networks of the further type.

16. A network status server comprising:
a processor;
a computer readable storage medium in communication with the processor, and containing software instructions that, when loaded into the processor and executed, transforms the server so as to provide network monitoring and aggregation tools that comprise:
a plurality of comparators that are operative to receive indications of status associated with a plurality of different components of physical networks or applications running on the physical networks, to compare the indications of status to respective metrics applicable to the different physical networks, and to output indications of respective performance status of the different physical networks; and
an aggregator that is operative to receive the output indications from the comparators, and to integrate the output indications into an aggregated network status display;

17. The server of claim 16, wherein the comparators are adapted to receive updates to the metrics, and further comprising: an output display device for presenting the aggregated network status display to at least one user; and a bus system coupling the processor to the computer readable storage medium and the output display device to facilitate signal transfers therebetween.

18. The server of claim 17, wherein the updates are created in response to human observations that link first performance anomalies occurring in at least a first one of the physical networks with at least second performance anomalies occurring and at least a second one of the physical networks.

19. The server of claim 18, wherein the updates specify how the comparators are to define the output indications of the first or second physical networks in response to occurrence of the first or second performance anomalies.

20. The server of claim 16, wherein the computer-readable storage medium includes computer-executable instructions stored thereon that, when executed by the server, cause the server to present a graphical user interface on the output display device, and to transform visible characteristics of the graphical user interface, wherein the graphical user interface comprises:
representations of the different physical networks;
representations of a plurality of status indicators, wherein the representations of the physical networks are associated with at least one of the status indicators, and wherein the status indicators represent respective performance levels computed for the different physical networks; and
wherein the graphical user interface is responsive to changes in the performance levels computed for the physical networks, to transform the status indicators associated with the physical networks.
